(19) United States
(12) Patent Application Publication
(10) Pub. No.: US 2008/0241674 A1
(43) Pub. Date: Oct. 2, 2008

(54) Electrode assembly and secondary battery including electrode assembly

(76) Inventor: Jinhee Kim, Yongin-si (KR)

Correspondence Address: ROBERT E. BUSHNELL, 1522 K STREET NW, SUITE 300, WASHINGTON, DC, 20005-1202, US

(21) Appl. No.: 11/892,800

(22) Filed: Aug. 27, 2007

(30) Foreign Application Priority Data
Mar. 29, 2007 (KR) 10-2007-0030789

(51) Int. Cl. H01M 4/00; H01M 2/02

(52) U.S. Cl. 429/164; 429/209

(57) ABSTRACT

An electrode assembly having a ceramic layer interposed between a positive electrode plate and a negative electrode plate, and a secondary battery including the electrode assembly includes: a positive electrode and a negative electrode plate having a ceramic layer coated on the positive electrode plate and the negative electrode plate and interposed between the two plates, and a rubber layer laminated on the ceramic layer to prevent deformation of the ceramic layer. The battery safety and reliability are improved by preventing cracking or separation of the ceramic layer from external shock by laminating the rubber layer on the ceramic layer.

### CLAIM OF PRIORITY

This application makes reference to, incorporates the same herein, and claims all benefits accruing under 35 U.S.C. §119 from an application for ELECTRODE ASSEMBLY AND SECONDARY BATTERY WITH THE SAME earlier filed in the Korean Intellectual Property Office on 29 Mar. 2007 and there duly assigned Ser. No. 10-2007-30789.

### BACKGROUND OF THE INVENTION

1. Field of the Invention

The present invention relates to an electrode assembly and a secondary battery including the electrode assembly, and more particularly, the present invention relates to an electrode assembly having a ceramic layer interposed between a positive electrode plate and a negative electrode plate, and a secondary battery including the electrode assembly.

2. Description of the Related Art

Generally, a secondary battery is a rechargeable battery that can be reused repeatedly by charging, as opposed to a disposable battery that can be used only once. The secondary battery is used as a main power supply of portable devices for communication, information processing and audio/video. Recently, secondary batteries have been developed rapidly because they are ultra light weight, and have high energy density, high output voltage, a low self-discharging rate, environment-friendliness, and a long life as a power supply.

Secondary batteries are divided into nickel-hydrogen (Ni-MH) batteries and lithium ion (Li-ion) batteries according to an electrode active material. Lithium ion batteries can also be divided into batteries using a liquid electrolyte, a solid polymer electrolyte or a gel phase electrolyte according to the electrolyte type. Lithium ion batteries are divided into can type batteries and pouch type batteries according to the shape of the container housing the electrode assembly.

Lithium ion batteries can provide a super compact battery because their energy density per weight is much higher than that of disposable batteries. An average voltage per a cell of lithium ion batteries and other secondary batteries, such as Nicad batteries or nickel-hydrogen batteries, is 3.6V and 1.2 V respectively. Lithium ion batteries are also 3 times more compact than other secondary batteries. The self-discharging rate of lithium ion batteries is about ⅓ that of Nicad batteries or nickel-hydrogen batteries because the self-discharging rate of lithium ion batteries is less than 5% a month at 20° C. Lithium ion batteries are environment-friendly because they do not use heavy metals, such as cadmium (Cd) or mercury (Hg), and have an advantage in that they can be charged and discharged more than 1000 times in a normal state. Accordingly, lithium ion batteries have been developed rapidly because of the advantages according to a recent development of information and communication technology.

A conventional secondary battery forms a bare cell by receiving an electrode assembly including a positive electrode, an negative electrode, and a separator in a can made of aluminum or an aluminum alloy, finishing an opening of an upper end of the can with a cap assembly, pouring the electrolyte into the can, and sealing the can. If the can is formed of aluminum or an aluminum alloy, it has advantages in that the battery can be lightweight because of aluminum is lightweight and non-corrosive even when used at a high pressure for long hours.

The sealed unit bare cell is received in a separate hard pack connected to safety devices, such as a Positive Temperature Coefficient (PTC) device, a thermal fuse and a protective circuit module, etc. or forms its external appearance by a mold made of hot melt resin.

The separator of the electrode assembly is installed to prevent an electrical short of the positive electrode plate and the negative electrode plate between two electrodes. However, when the separator arranged between two electrodes does not have sufficient permeability and wettability, it limits the movement of lithium ions between the two electrodes so that the electrical characteristics of the battery are degraded.

The separator itself also functions as a safety device to prevent the battery from overheating. However, the separator may be damaged by an increase in battery temperature which continues for a long time in spite of microholes closing the separator when the battery temperature is rapidly increased due to external heat transitions, etc.

Additionally, when a large current flows in a high capacity battery in a short time, the possibility of an electrical short due to separator damage is increased because the separator melting continues by heat already generated, rather than decreasing the battery temperature by current shutdown even if microholes of the separator are closed.

Accordingly, to stably prevent electrical shorts between the electrodes even at a high temperature, the separator includes a ceramic layer of a porous membrane, formed by combining ceramic filler particles with a thermostable binder, and coated on the positive electrode plate or the negative electrode plate.

When the cohesive force of an electrode active material layer coated on an electrode collector is weak, there is a problem in that the ceramic layer on the active material layer is cracked due to cracking of the active material layer, which is a base of the ceramic layer, when an electrode coated by the ceramic layer on the electrode active material layer is wound.

When a beginning part of the electrode assembly winding is folded to about 180°, and the cohesive force of the electrode active material layer coated on the electrode collector is weak, or when the flexibility of the electrode active material layer is poor, the ceramic layer may be cracked, or the ceramic layer may be separated with the electrode active material layer from the electrode collector. In this case, the battery safety can not be improved even if the ceramic layer is coated and bonded on the electrode plate.

Accordingly, when the cohesive force of the electrode active material layer against the electrode collector is weak, or when the flexibility of the electrode active material layer is poor, it is necessary to change the electrode assembly structure to prevent the ceramic layer from cracking and separating.

### SUMMARY OF THE INVENTION

An object of the present invention is to provide an electrode assembly that can prevent cracking or separation of a ceramic layer from external shock to improve battery safety and reliability, and a secondary battery including the electrode assembly.

According to one aspect of the present invention, an electrode assembly is provided including: a positive electrode and a negative electrode plate; a ceramic layer coated on the positive electrode plate and the negative electrode plate and interposed between the two plates; and a rubber layer laminated on the ceramic layer to prevent deformation of the ceramic layer.

The rubber layer may be in contact with an electrode active material layer of an electrode opposite to an electrode coated by the ceramic layer by winding.

The rubber layer may be formed with a thickness of 1 to 10 μm.

The rubber layer may be formed with a net structure.

The rubber layer may be formed by using a foaming agent.

The rubber layer may be formed by spray coating a solution of rubber macromolecule materials on the ceramic layer.

The rubber layer may include the same binder as that of the ceramic layer.

The rubber layer may be formed of an alkyl acrylate polymer or alkoxy alkyl acrylate polymer or their copolymers.

A ceramic filler of the ceramic layer may be formed of alumina (Al₂O₃).

The ceramic filler may be formed with a spherical shape, a dumbbell shape, an oval shape or an irregular shape.

According to an electrode assembly and a separator interposed between two plates of the electrode assembly, the separator including a ceramic layer and a rubber layer laminated on the ceramic layer; a can; and a cap assembly.

The rubber layer maybe in contact with the electrode active material layer of an electrode opposite to an electrode coated by the ceramic layer by winding, and formed with a thickness of 1 to 10 μm.

The rubber layer may be formed by spray coating a solution of rubber macromolecule materials on the ceramic layer, and includes the same binder as that of the ceramic layer.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of an electrode assembly according to one exemplary embodiment of the present invention; and

FIG. 2 is a view of the electrode assembly at the time of nail penetration according to one exemplary embodiment of the present invention.

### DETAILED DESCRIPTION OF THE INVENTION

Hereinafter, an exemplary embodiment of the present invention is described in detail with reference to the accompanying drawing. The aspects and features of the present invention and methods for achieving the aspects and features will be apparent by referring to the described embodiment. However, the present invention is not limited to the embodiment disclosed hereinafter, but can be implemented in diverse forms. The matters defined in the description, such as the detailed construction and elements, are merely specific details provided to assist those of ordinary skill in the art in a comprehensive understanding of the present invention, and the present invention is only defined within the scope of the appended claims.

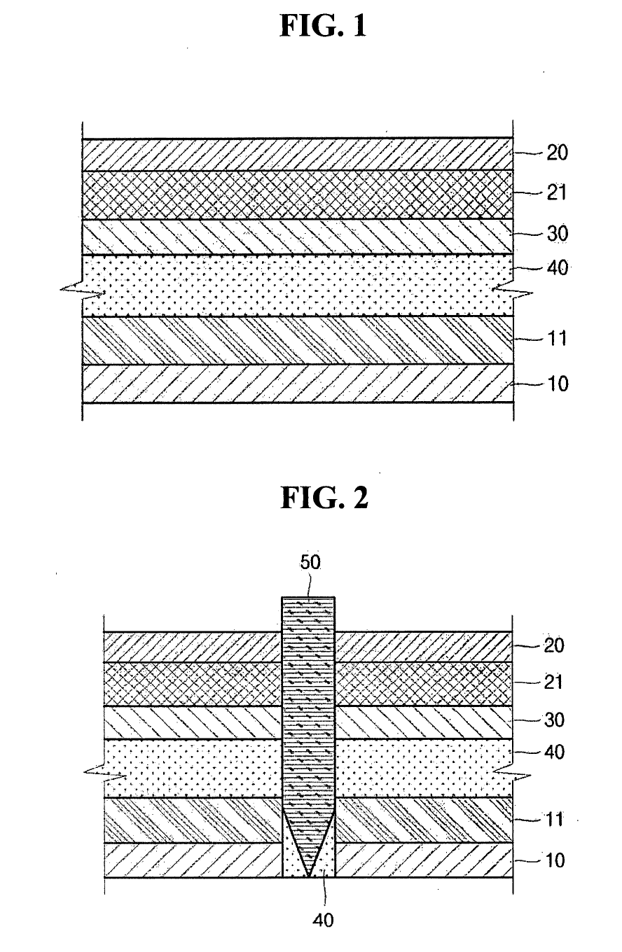

Referring to FIG. 1, an electrode assembly according to one exemplary embodiment of the present invention includes a positive electrode plate, an negative electrode plate, a ceramic layer 30 interposed between the positive electrode plate and the negative electrode plate for preventing an electrical short of the positive electrode plate and the negative electrode plate, and enabling only Li ions to be transferred, and a rubber layer 40 laminated on the ceramic layer 30, wherein the positive electrode plate and the rubber layer 40, and the ceramic layer 30 and the negative electrode layer are formed by laminating and winding.

The positive electrode plate includes a positive electrode collector 10, a positive electrode active material layer 11, and a positive electrode tap (not shown).

The positive electrode collector 10 is formed of thin aluminum foil. The positive electrode active material layer 11 based on lithium oxide is coated on both faces of the positive electrode collector 10. A lithium oxide, such as LiCoO₂, LiMn₂O₄, LiNiO₂, and LiMnO₂, etc. is used as the positive electrode active material. An uncoated positive electrode portion, which is a region in which the positive electrode active material layer 11 has not been coated, is formed with a predetermined interval at both ends of the positive electrode collector 10.

The positive electrode tap (not shown) is attached to an internal circumferential portion of the uncoated positive electrode portion by ultrasonic welding or laser welding. The positive electrode tap (not shown) is formed of nickel, and its upper end portion is arranged so as to protrude above the upper end portion of the positive electrode collector 10.

The negative electrode plate includes a negative electrode collector 20, a negative electrode active material layer 21 and a negative electrode tap (not shown).

The negative electrode collector 20 is formed of thin copper foil, and the negative electrode active material layer 21 based on carbon materials is coated on both faces of the negative electrode collector 20. A carbon group material, silicon, tin, tin oxide, composite tin alloys, and a transition metal oxide, etc. can be used as the negative electrode active material. An uncoated negative electrode portion, which is a region in which the negative electrode active material layer 21 has not been coated, is formed with a predetermined interval at both ends of the negative electrode collector 20.

The negative electrode tap (not shown) is formed of nickel, and attached to an internal circumferential portion of the uncoated negative electrode portion by ultrasonic welding or laser welding. The negative electrode tap (not shown) is arranged so that its upper end portion protrudes above the upper end part of the negative electrode collector 20.

The ceramic layer 30 is formed by coating a ceramic paste, which is made by mixing a ceramic filler, a binder and a solvent, on the positive electrode plate or the negative electrode plate. The ceramic layer 30 is formed by being coated on the negative electrode active material layer 21 of the negative electrode plate. The ceramic layer 30 may be formed by a method coating only each side of the positive electrode plate or the negative electrode plate, or both sides thereof.

The ceramic layer 30 has the same function as a conventional olefin film separator. The ceramic layer 30 prevents an electrical short between the positive electrode plate and the negative electrode plate because it has an electrical insulating property and no electrical conductivity. The ceramic layer 30 is formed by being coated with a thickness of 1 to 40 μm, preferably, with a thickness of 1 to 30 μm on the negative electrode plate.

The ceramic filler may be formed of a semiconductor filler having a band gap, or alumina (Al₂O₃) or zirconia (ZrO₂) or titanium oxide (TiO₂) or silica (SiO₂). The ceramic filler may be formed in a spherical shape, a dumbbell shape, an oval shape or an irregular shape.

It is desirable that the binder is mainly made of an acrylate polymer or metha acrylate polymer, which is one of an acrylate rubber group, or their copolymers that withstand heat of more than 200° C. as a macromolecule resin. It is desirable that a small amount of the binder is used in a slurry for forming a porous membrane. The ceramic filler and the binder in the porous membrane may be mixed with a ratio of 98 to 2 or 85 to 15 by mass. The ceramic filler may be prevented from being covered completely by the binder with these ratios. In other words, ions conducting into the ceramic filler being limited by the binder covering the ceramic filler can be avoided.

The ceramic layer 30 coated on the negative electrode plate has high stability with respect to internal electrical shorts because the decomposition temperature of ceramic powders is more than 500° C., and the decomposition temperature of the binder is more than 250° C. The ceramic paste is not shrunk or molten at high temperature because it is coated and adhered on the negative electrode plate or the positive electrode plate. Accordingly, only the internal electrical short portion is a slightly damaged, so that the electrical short portion is not widened because the nearby ceramic layer is not shrunk or molten.

The battery overcharge safety is also improved by maintaining a predetermined voltage of 5 to 6 V and a temperature of less than 100° C. because an overcharging current is consumed by making a soft short when overcharged.

Additionally, an electrolyte penetration rate is improved because of high porosity ceramic powders, and the battery life and its high-rate discharging property are improved because of their excellent electrolyte-holding property.

The rubber layer 40 is laminated on the ceramic layer 30 and prevents deformation of the ceramic layer 30. The rubber layer 40 may be in contact with the electrode active material layer 11 opposite to an electrode coated by the ceramic layer by winding. The rubber layer 40 is coated on the ceramic layer 30, incorporated with the ceramic layer 30, and may be in contact with the positive electrode active material layer 11 by winding.

If the rubber layer 40 gets thicker, the battery resistance may be increased by interrupting the transfer of lithium ions. Accordingly, the rubber layer 40 may be formed with a thickness of 1 to 10 μm so as to improve the battery safety and performance.

Rubber macromolecule materials consisting of the rubber layer 40 are dispersed in an organic solvent, such as NMP, etc., and their concentration can be controlled by increasing or decreasing the amount of solvent. As the rubber macromolecule materials have pores with a net structure, lithium ions may be transferred smoothly into the rubber layer 40. More pores may be formed by using a foaming agent for the rubber layer 40.

The rubber layer 40 may be formed by spray coating a solution of rubber macromolecule materials on the ceramic layer 30.

The rubber layer 40 may be also formed of the same binder, which is a macromolecule of acryl rubber group, as that of the ceramic layer, or formed of alkyl acrylate polymer or alkoxy alkyl acrylate polymer or their copolymers.

Table 1 below shows results of a voltage withstanding property, life and nail penetration of the battery made with various electrodes.

The voltage withstanding property shows a limit that the battery itself withstands high voltage when supplied with the predetermined voltage. In Table 1, the voltage withstanding property was written as OK when a resistance value ranged from 0.001 to 999 MΩ and as NG (Not Good) when the resistance value was less than 0.001 MΩ.

If the resistance value gets higher, the voltage withstanding property gets better, and if the ceramic layer gets thinner, the resistance value gets lower in proportion to a thickness of the ceramic layer. The resistance values ranging from 100 to 500 MΩ were measured at 250V when a thickness of the ceramic layer is in the ranges of 15 to 20 μm.

Life properties of 20 batteries were calculated in % by 1^{st} capacity divided by 500^{th} capacity when charging at IC/4.2V and discharging at IC/3V. The penetration test was noted as OK when there was no firing or explosion, and NG when there was firing or explosion after 20 batteries charged at 4.35V were completely penetrated by the nail. Numbers in front of OK and NG means the number of tested batteries.

TABLE 1

| | | | | Jelly Roll | | |
|---|---|---|---|---|---|---|
| | Electrode shape | | Separator | Voltage | | |
| | Negative electrode Active | | Polyolefin | Withstanding | Battery Performance | |
| | Material Layer Base | | Film (16 μm) | Property | Penetration | Life (%) |
| Comparative | — | — | Exist | OK | 20 NG | 89 |
| example 1 | | | | | | |
| Comparative | Ceramic Layer | — | Exist | OK | 11 NG | 91 |
| example 2 | 15 μm | | | | | |
| Comparative | Ceramic Layer | — | None | OK | 9 NG | 90 |
| example 3 | 15 μm | | | | | |
| Comparative | Rubber layer | — | Exist | OK | 20 NG | 89 |
| example 4 | 5 μm | | | | | |
| Comparative | Rubber layer | — | Exist | OK | 20 NG | 85 |
| example 5 | 10 μm | | | | | |
| Comparative | Rubber layer | — | Exist | OK | 20 NG | 67 |
| example 6 | 15 μm | | | | | |
| Comparative | Rubber layer | — | None | NG | — | — |
| example 7 | 15 μm | | | | | |
| Example 1 | Ceramic Layer | Rubber layer | Exist | OK | 20 NG | 88 |
| | 15 μm | 5 μm | | | | |
| Example 2 | Ceramic Layer | Rubber layer | Exist | OK | 20 NG | 79 |
| | 15 μm | 10 μm | | | | |
| Example 3 | Ceramic Layer | Rubber layer | Exist | OK | 20 NG | 53 |
| | 15 μm | 15 μm | | | | |
| Example 4 | Ceramic Layer | Rubber layer | None | OK | 20 NG | 90 |
| | 15 μm | 5 μm | | | | |
| Example 5 | Ceramic Layer | Rubber layer | None | OK | 20 NG | 86 |
| | 15 μm | 10 μm | | | | |
| Example 6 | Ceramic Layer | Rubber layer | None | OK | 20 NG | 65 |
| | 15 μm | 15 μm | | | | |

The comparative example 1 battery includes a polyolefin film separator interposed between a negative electrode and a positive electrode. The negative electrode was formed by coating the negative electrode active material on a copper collector, and the positive electrode was formed by coating the positive electrode active material on an aluminum collector.

The comparative example 2 battery includes the polyolefin film separator interposed between the positive electrode and the dried electrode after coating the ceramic layer with a thickness of 15 μm on the negative electrode.

The comparative example 3 battery is the same as the comparative example 2 battery but did not include the polyolefin film separator interposed between a positive electrode and the negative electrode since the ceramic layer itself could function as the separator.

The comparative examples 4 to 6 batteries include the polyolefin film separator interposed between the positive electrode and the dried electrode after coating the rubber layer with a thickness of 5, 10, and 15 μm respectively on the negative electrode.

The comparative example 7 battery is the same as the comparative example 6 battery but did not include the polyolefin film separator interposed between the positive electrode and the negative electrode to determine if the rubber layer itself could function as the separator.

In the examples 1 to 6, the ceramic layer was coated with a thickness of 15 μm on the negative electrode and dried, and then the battery was formed by coating the rubber layer with a thickness of 5, 10, and 15 μm, respectively. The battery in the examples 1 to 3 was made by using the polyolefin film separator as a separating membrane, but the batteries in the examples 4 to 6 were made without interposing the polyolefin film separator. If the ceramic layer was coated, it could function as the separator without the polyolefin film separator.

The voltage withstanding property of the battery interposed by the polyolefin film separator was OK because the polyolefin film separator itself was the separating membrane having the voltage withstanding property. The ceramic layer had the voltage withstanding property because if the ceramic layer existed, it could function as the separator without the polyolefin film separator.

In the comparative example 7, when the rubber layer was coated with a thickness of 15 μm on the negative electrode without the polyolefin film separator or the ceramic layer, the battery did not have the voltage withstanding property when a high voltage of 250V was supplied. If there is no predetermined level of the voltage withstanding property, charging/discharging may be impossible, and charging/discharging efficiency is low, and there is explosion danger in the worst case at the time of charging. Accordingly, the battery could not be assembled in the comparative example 7.

The batteries according to the comparative examples and the examples were formed, and their penetration tests were performed by piercing the batteries with a nail under overcharged state at 4.35V.

When the battery was penetrated in the comparative example 1, the separator was shrunk due to joule heat generated around the torn polyolefin film separator, and an electrical short area was expanded due to shrinkage and melting of the separator, so that all 20 batteries exploded.

In the comparative examples 2 and 3, the ceramic layer was not melted or shrunk because the ceramic layer was coated on the electrode. Accordingly, the electrical short area around the penetrated region was not enlarged as much as that of the polyolefin film separator. However, as the battery was charged at 4.35V higher than normal use range, the battery was unstable due to lithium dendrite extracted a lot, and the ceramic layer around the penetration was cracked, so that the battery might be exploded.

In the comparative examples 4 to 6, the rubber layer instead of the ceramic layer was coated with a thickness of 5, 10, and 15 μm respectively on a negative electrode, and the polyolefin separator was included. As there was no ceramic layer, enlargement of an electrical short area was not prevented due to melting and shrinkage of the polyolefin separator, so that all 20 batteries exploded.

Comparing the comparative example 4 with the comparative example 6, the batteries' life property was not badly influenced in case where the rubber layer is 5 μm thickness, but the batteries' life property became worse in case where the rubber layer was about 15 μm thickness. It is because if the rubber layer is formed too thick, it functions as resistance of the battery.

Referring to FIG.2, if the rubber layer was coated on the ceramic layer in the examples 1 to 6, all 20 batteries did not explode because the rubber layer 40 was extended to cover the outside of the nail 50, and prevented cracking and separation of the ceramic layer 30.

In the electrode laminated by the ceramic layer, when the adhesive force of the electrode active material layer and the electrode collector was weak or flexibility of the electrode active material layer was weak, the electrode active material layer was cracked by winding.

The rubber layer prevents cracking of the ceramic layer from cracking of the electrode active material layer, and scratching or separating of the ceramic layer surface during transportation process. As the rubber layer 40 prevented deformation of the ceramic layer and protected it, stability of the ceramic layer 30 was improved according to thickness increase of the rubber layer to some level. However, as shown examples 3 and 6 if the rubber layer was 15 μm thickness, the battery life property was degraded. Therefore, it is desirable that a thickness of the rubber layer 40 coated on the ceramic layer 30 ranges from 1 to 10 μm.

An electrode assembly and the secondary battery including the electrode assembly according to one exemplary embodiment of the present invention is explained in detail as follows.

An electrode assembly and the secondary battery including the electrode assembly according to one exemplary embodiment of the present invention includes an electrode assembly, an assembly of a can and a cap sealing an open upper part of the can.

As described above, the electrode assembly includes a positive electrode plate and a negative electrode plate, and a separator interposed between the positive electrode plate and the negative electrode plate. The separator includes a ceramic layer and a rubber layer laminated on the ceramic layer.

The rubber layer may be in contact with electrode active material layer opposite to an electrode coated by the ceramic layer by winding, and formed with a thickness of 1 to 10 ∞m. The rubber layer may be formed by spray coating a solution of rubber macromolecule materials on the ceramic layer. The rubber layer may include the same binder as that of the ceramic layer.

On the other hand, the secondary battery includes an assembly of the can and the cap.

The can is formed of aluminum or an aluminum alloy having an approximately rectangular shape. The electrode assembly is inserted through an open upper part of the can, and the can itself functions as a terminal.

The cap assembly includes a plate-shaped cap plate having a size and a shape corresponding to an open upper part of the can. A tube-shaped gasket is installed between the cap plate and an electrode terminal penetrating a center part of the cap plate for electrical insulation. An insulation plate is arranged on a lower part of the cap plate, and a terminal plate is installed on a lower part of the insulation plate. A lower face part of the electrode terminal is electrically coupled to the terminal plate. A positive electrode tap extending from the positive electrode plate is welded on a lower face part of the cap plate, and a negative electrode tap extending from the negative electrode plate is welded in a state having a bending part of a zigzag shape. An electrolyte injection hole is formed on one side of the cap plate, and a plug is installed to seal the electrolyte injection hole after the electrolyte is poured into the can. The plug is formed by mechanically pressing-in a ball-shaped basic material made of aluminum or an aluminum containing metal on the electrolyte injection hole. The plug is welded to the cap plate at a periphery of the electrolyte injection hole so as to seal it. The cap assembly is combined with the can by welding a peripheral part of the cap plate to a side wall of a can opening.

A function of an electrode assembly and the secondary battery including the electrode assembly according to one exemplary embodiment of the present invention is as follows.

The ceramic layer is coated on the positive electrode plate or the negative electrode plate to prevent an electrical short of the positive electrode plate and the negative electrode plate, and the rubber layer is laminated on the ceramic layer to prevent deformation of the ceramic layer.

As the rubber layer has high elongation and flexibility, it can prevent separation and scratching of the ceramic layer. The rubber layer can also prevent cracking of the ceramic layer due to its high flexibility by winding. Additionally, the battery safety can be improved by lengthening of the rubber layer with high elongation and covering the nail surface if the battery is penetrated by a nail.

The fuel cell system according the present invention produces the following effect.

The battery safety and reliability can be improved by preventing cracking or separation of the ceramic layer from external shock by laminating the rubber layer on the ceramic layer.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as being limitations of the present invention.

What is claimed is:

1. An electrode assembly comprising:
a positive electrode and a negative electrode plate;
a ceramic layer coated on the positive electrode plate and the negative electrode plate and interposed between the two plates; and
a rubber layer laminated on the ceramic layer to prevent deformation of the ceramic layer.

2. The electrode assembly of claim 1, wherein the rubber layer is in contact with an electrode active material layer on an electrode opposite to an electrode coated by the ceramic layer.

3. The electrode assembly of claim 1, wherein the rubber layer has a thickness in a range of 1 to 10 μm.

4. The electrode assembly of claim 1, wherein the rubber layer has a net structure.

5. The electrode assembly of claim 1, wherein the rubber layer includes a foaming agent.

6. The electrode assembly of claim 1, wherein the rubber layer comprises a spray coating of a solution of rubber macromolecular materials on the ceramic layer.

7. The electrode assembly of claim 1, wherein the rubber layer includes the same binder as that of the ceramic layer.

8. The electrode assembly of claim 1, wherein the rubber layer comprises an alkyl acrylate polymer or an alkoxy alkyl acrylate polymer or their copolymers.

9. The electrode assembly of claim 1, wherein a ceramic filler of the ceramic layer comprises alumina (Al₂O₃).

10. The electrode assembly of claim 9, wherein the ceramic filler has at least one of a spherical shape, a dumbbell shape, an oval shape or an irregular shape.

11. A secondary battery comprising:
an electrode assembly and a separator interposed between two plates of the electrode assembly, the separator including a ceramic layer and a rubber layer laminated on the ceramic layer;
a can to receive the electrode assembly; and
a cap assembly to cover the can.

12. The secondary battery of claim 11, wherein the rubber layer is in contact with electrode active material layer of an electrode opposite to an electrode coated by the ceramic layer.

13. The secondary battery of claim 11, wherein the rubber layer has a thickness in a range of 1 to 10 μm.

14. The secondary battery of claim 11, wherein the rubber layer comprises a spray coating of a solution of rubber macromolecule materials on the ceramic layer.

15. The secondary battery of claim 11, wherein the rubber layer includes the same binder as that of the ceramic layer.

16. The secondary battery of claim 11, wherein the rubber layer comprises an alkyl acrylate polymer or an alkoxy alkyl acrylate polymer or their copolymers.

17. The secondary battery of claim 11, wherein a ceramic filler of the ceramic layer comprises alumina (Al₂O₃).

18. The secondary battery of claim 17, wherein the ceramic filler has at least one of a spherical shape, a dumbbell shape, an oval shape or an irregular shape.
